(19) United States
(12) Patent Application Publication
(10) Pub. No.: US 2018/0266657 A1
(43) Pub. Date: Sep. 20, 2018

(54) APPARATUS AND SYSTEM FOR A COMPACT ILLUMINATION DEVICE

(71) Applicant: LED Lenser Corp. Ltd., Yangjiang City (CN)

(72) Inventors: Michael BRANDT, Solingen (DE); Ulrich MAI, Solingen (DE)

(21) Appl. No.: 15/458,390

(22) Filed: Mar. 14, 2017

(51) Int. Cl. F21V 7/04; F21L 4/00; F21V 23/04; F21V 21/40; F21V 23/00; F21V 31/00

(52) U.S. Cl. CPC F21V 7/041; F21L 4/00; F21V 23/04; F21Y 2105/18; F21V 23/005; F21V 31/005; F21V 23/0428; F21V 21/406

(57) ABSTRACT

A light emitting device is provided that is generally configured to have a compact shape and a broad pattern of light emission. An example light emitting apparatus may include: a redirector disposed about an axis, the redirector having a first end and a second end, where the first end is narrower than the second end, the redirector defining a cavity between the first end and the second end; a power source at least partially disposed within the cavity defined by the redirector; and a light source disposed around the first end of the redirector about the axis, where the light source is powered by the power source and is configured to project light substantially parallel to the axis, toward the second end of the redirector. The redirector may include a frustoconical shape.

### FIELD

Embodiments of the present invention generally relate to systems and methods for providing illumination and, more particularly, to an apparatus and system for a compact illumination device.

### BACKGROUND

Electric light sources exist in a variety of form factors from residential or commercial light fixtures to hand-held flashlights. Conventional incandescent light bulbs have given way to more efficient fluorescent light bulbs and compact florescent light (CFL) bulbs to provide substantially similar light while consuming less power. While a florescent light is more efficient than an equivalently bright incandescent light, light-emitting diodes (LEDs) are more efficient still at producing an equivalent or brighter light in a particularly compact form factor.

LEDs were initially relatively expensive as compared to incandescent or florescent lights, and were not suitable for many applications. Additionally, low intensity and limited color options for LEDs limited their usefulness. Recent developments in the field of LEDs have caused LED light sources to become ubiquitous replacements or supplements to conventional light sources. Further, LEDs may be packaged in considerably smaller form factors than equivalently bright incandescent lights or florescent lights. LEDs may now be found in flashlights and other portable light sources which benefit from their compact size and energy efficiency.

As LEDs function in a manner different than that of florescent lights or incandescent lights, LEDs may offer functionality and utility previously not available in compact form factors, such as compact illumination devices. Therefore, it may be desirable to exploit the capabilities of LEDs in new compact form factors.

### SUMMARY

Embodiments described herein provide a light emitting device generally configured to have a compact shape and a broad pattern of light emission. According to an example embodiment, a light emitting apparatus is provided. The light emitting apparatus may include: a redirector disposed about an axis, the redirector having a first end and a second end, where the first end is narrower than the second end, the redirector defining a cavity between the first end and the second end; a power source receiving area at least partially disposed within the cavity defined by the redirector; and a light source disposed around the redirector proximate the first end of the redirector about the axis, where the light source is powered by the power source and is configured to project light substantially parallel to the axis, toward the second end of the redirector. The redirector may include a frustoconical shape. The redirector may include a microstructure of a plurality of angled steps disposed about the frustoconical shape. The plurality of angled steps may be arranged concentrically about the axis and offset along a length of the axis to form the frustoconical shape.

According to some embodiments, the power source of the light emitting apparatus may be received entirely within the cavity defined between the first end and the second end of the redirector. The light source may include a plurality of light emitting diodes arranged on a circuit board, where the circuit board is positioned at the first end of the redirector in a plane orthogonal to the axis of the redirector. The plurality of light emitting diodes may be configured with a primary axis of emission along which a relatively higher proportion of light emitted from the diode is directed, where the primary axis of emission is parallel to the axis of the redirector. Embodiments may include a base positioned at the second end of the redirector and a top positioned at the first end of the redirector, where the top may include a cavity defined therein housing a light emitting diode drive circuit board and a power switch configured to turn the light source on and off and control light functions, such as dimming (brighter or less bright) or progressing through different increments of brightness. The top further comprises a first connection port and a second connection port, where both the first connection port and the second connection port are charging ports for receiving power to charge the power source. The first connection port may be, for example, a micro universal serial bus (micro-USB) port and the second connection port may be a standard universal serial bus (USB) port.

Embodiments described herein may include a cable configured to connect to both the first connection port and the second connection port, where: the cable functions as a handle in response to being connected to both the first connection port and the second connection port; the cable functions as a charging cable in response to being plugged into the first connection port and a powered standard USB port; and the cable functions as a charging cable in response to being plugged into the second connection port and a powered micro USB port. The light emitting apparatus may also include a lens disposed between the base and the top surrounding the redirector about the axis.

Embodiments described herein may provide a redirector for a light emitting apparatus. The redirector may include: a generally frustoconical body extending along an axis between a first end and a second end, where the first end has a first diameter and the second end has a second diameter, larger than the first diameter; a cavity defined within the body between the first end and the second end; and a plurality of concentric steps arranged along the frustoconical body, where the concentric steps each include a first portion and a second portion, where the first portion includes a substantially cylindrical surface extending about and parallel to the axis, and where the second portion includes an interface between the first portions of adjacent steps. The second portion may include a radiused surface between the first portions of adjacent steps. The second portion of each step may be configured to redirect light received along an illumination axis parallel to the axis of the body. At least the second portion of each step may include reflective material. The cavity may be configured to receive therein a power source for providing power to a light source disposed about the first end of the redirector body.

Some embodiments may provide a light emitting apparatus including: a generally frustoconical redirector extending along an axis between a first end and a second end, where the first end has a first diameter and the second end has a second diameter, larger than the first diameter; a plurality of concentric steps arranged along the frustoconical body, where the concentric steps each include a first portion and a second portion, where the first portion includes a generally cylindrical surface extending about and parallel to the axis, and the second portion includes an interface between the first portions of adjacent steps; and a light source disposed about the redirector proximate the first end of the redirector and configured to emit light along an axis of major emission toward the second end of the redirector. The major axis of emission may be substantially parallel to the axis of the redirector, and the second portion of each of the steps of the redirector may be configured to redirect the light emitted by the source. The generally frustoconical redirector may define a cavity therein, where the cavity is configured to at least partially receive therein a power supply for providing power to the light source.

### BRIEF DESCRIPTION OF THE DRAWINGS

Having thus described the invention in general terms, reference will now be made to the accompanying drawings, which are not necessarily drawn to scale, and wherein:

FIG. 1 depicts an illumination device according to an example embodiment of the present invention;

FIG. 2 illustrates an illumination device according to another example embodiment of the present invention;

FIG. 3 illustrates a redirector for an illumination device according to an example embodiment of the present invention and a detail view thereof;

FIG. 4 depicts a perspective view of a redirector including an illumination pattern according to an example embodiment of the present invention;

FIG. 5 illustrates a cut-away view of a redirector according to an example embodiment of the present invention;

FIG. 6 is an exploded view of an illumination device according to an example embodiment of the present invention; and

FIG. 7 depicts a section view of a portion of an illumination device according to an example embodiment of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the present invention are generally described and depicted as embodied within a lantern form factor; however, as will be apparent, embodiments of the present invention may be scalable and may be used in a number of form factors, such as maritime lighting, search and rescue lights (e.g. floodlights), and signal lights, among others. As such, the disclosure is intended to merely provide example embodiments and not to be limiting. Various form factors, and particularly compact form factors of light emitting devices, may benefit from embodiments of the invention described herein.

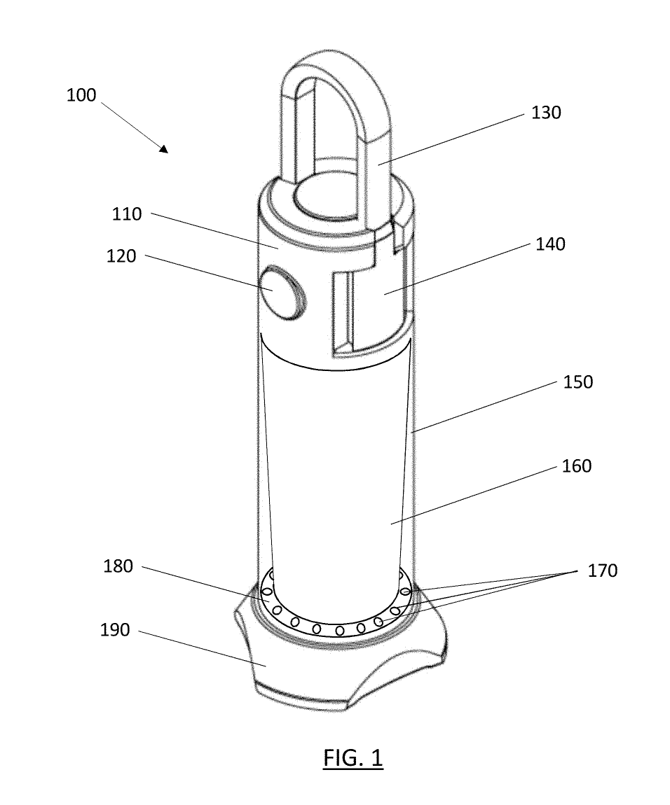

Referring now to the example of FIG. 1, embodiments of the present invention may be implemented in lanterns, such as the lantern 100 of FIG. 1 with a lantern top 110 including an operating button 120, and a carry or mounting handle 130. The mounting handle may be attached to the lantern top 110 by connector 140 and a second connector on the opposite side of the lantern top, described further below. The top of the lantern 110, as illustrated, is attached to a body of the lantern 100 including a housing 150 or lens surrounding a redirector 160. According to the embodiment of FIG. 1, the redirector has a tapered, frustoconical shape with a narrow end proximate the one end, which in the embodiment of FIG. 1 is a base 190 of the lantern and a wider end proximate the opposite end, which in the illustrated embodiment is the lantern top 110. The narrow end of the frustoconical shape of the redirector 160 may be encircled with a light source, such as a plurality of LEDs 170 disposed on a circuit board 180. The light source (LEDs 170) may have a primary axis of emission of light, where the light from each LED is greatest, and that axis may be in the upward direction, toward the angled reflecting surface of the redirector 160. The LEDs 170 may be oriented with their respective primary axis of emission of light that is substantially parallel to the axis of the frustoconical shape of the redirector 160, or possible angled slightly (e.g., 0-10 degrees) toward the axis of the redirector 160. Substantially parallel may include parallel or within a finite measure of parallel, such as within two degrees. Manufacturing tolerances may result in some variation or deviation from precisely parallel, such that “substantially parallel” includes parallel and within such manufacturing tolerances of parallel. The illumination pattern caused by light from the LEDs 170 encountering the redirector 160 is detailed further below.

According to the illustrated embodiment, the base 190 of the lantern may be a removable stabilizing base as depicted in FIG. 1 that encircles a cylindrically shaped lantern end, not shown, but generally disposed below the illustrated LEDs 170. The cylindrically shaped lantern end may be removable from the lantern body to access a cavity disposed within the redirector 160 in which a power source may be stored, such as a battery, rechargeable battery, capacitor, etc. In an embodiment in which the base 190 is removable, it may be retained on the cylindrically shaped lantern end by a magnet to enable interchangeability of the base 190 and attachment of the lantern to a magnetically attractive surface.

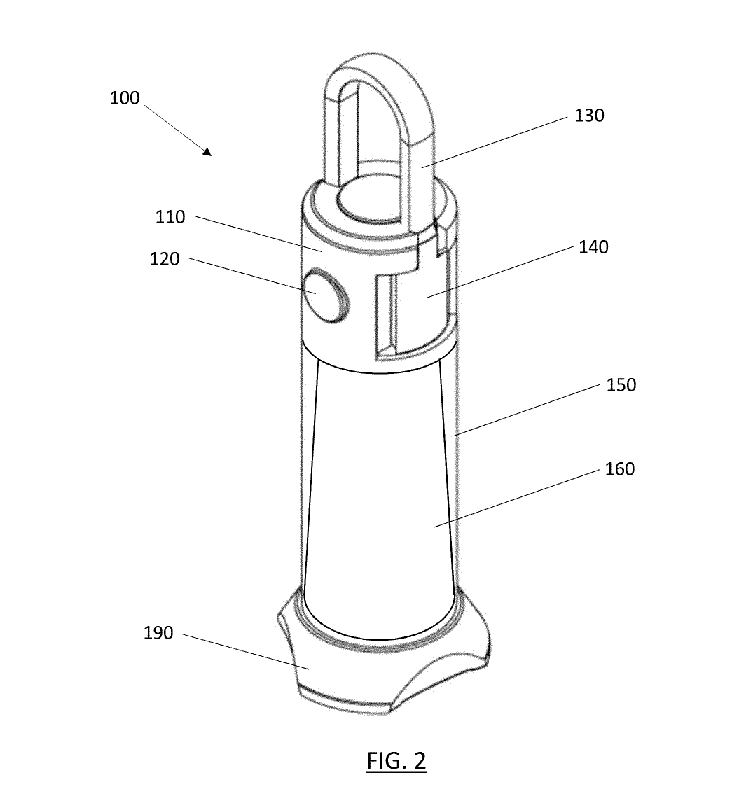

While FIG. 1 shows one arrangement of elements of a lantern of an example embodiment of the present invention, FIG. 2 illustrates a second arrangement of elements of a lantern of an example embodiment of the present invention. According to the embodiment of FIG. 2, the redirector 160 may be inverted relative to the embodiment of FIG. 1, with the narrow end of the frustoconical shape disposed proximate the top 110 of the lantern while the wide end of the frustoconical shape is disposed proximate the base 190 of the lantern 100. In the illustrated embodiment of FIG. 2, the plurality of LEDs may be disposed about the narrow end of the redirector 160 proximate the interface between the top 110 of the lantern 100 and the housing 150/redirector 160. In this manner, the LEDs have a primary axis of emission substantially along the axis of the redirector 160, but toward the base in the opposite direction of the LEDs of FIG. 1. Again, the primary axis of emission of the LEDs of the lantern of FIG. 2 may be inclined (e.g., 0-10 degrees) toward the axis about which the redirector 160 is disposed.

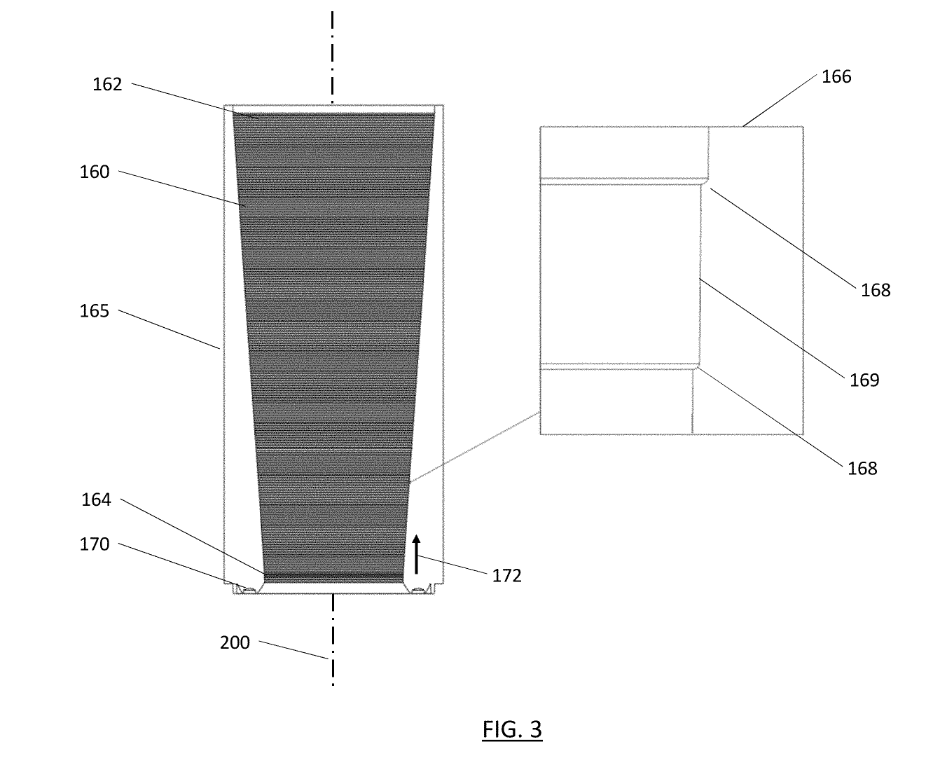

According to some embodiments, the redirector 160 may have a surface configured to enhance the reflection and/or refraction of light in the desired direction away from the lantern 100. The surface of the redirector 160 may include a multitude of small steps or micro-steps, where the redirector is a series of concentric circles separated axially along the axis through the redirector 160. FIG. 3 illustrates an example embodiment of such a redirector 160 including a frustoconical shape extending from a wide end 162 to a narrow end 164. The narrow end 164 of the redirector 160 is surrounded by LEDs 170 that are positioned with their major axis of emission along which the highest level of light is emitted from the LEDs 170 is directed up, along arrow 172, toward the micro-steps of the redirector. The major axis of emission is substantially parallel to the axis 200 about which the redirector is disposed. Detail view 166 of FIG. 3 illustrates the micro-steps 168 of the redirector 160 that form the tapered, frustoconical shape of the redirector. The steps 168 may be radiused, chamfered, or beveled in such a way as to promote reflection or redirection of light from the LEDs 170 in the desired direction away from the lantern, while the portion 169 of the redirector between the steps may be substantially parallel to the axis 200. The concentricity of the steps need not be absolute, but may be slightly offset from one another due to manufacturing tolerances, such that the “concentricity” of the steps includes substantially concentric or essentially concentric without requiring absolute concentricity. The deviation from absolute concentricity may be relatively small, such as, at most, the width of a step between adjacent parallel portions 169. Similarly, the portions 169 between the steps 168 may not be absolutely parallel to the axis defined by the redirector. There may be slight offsets within manufacturing tolerances, such as the tolerances of an injection mold used to make the redirector 160.

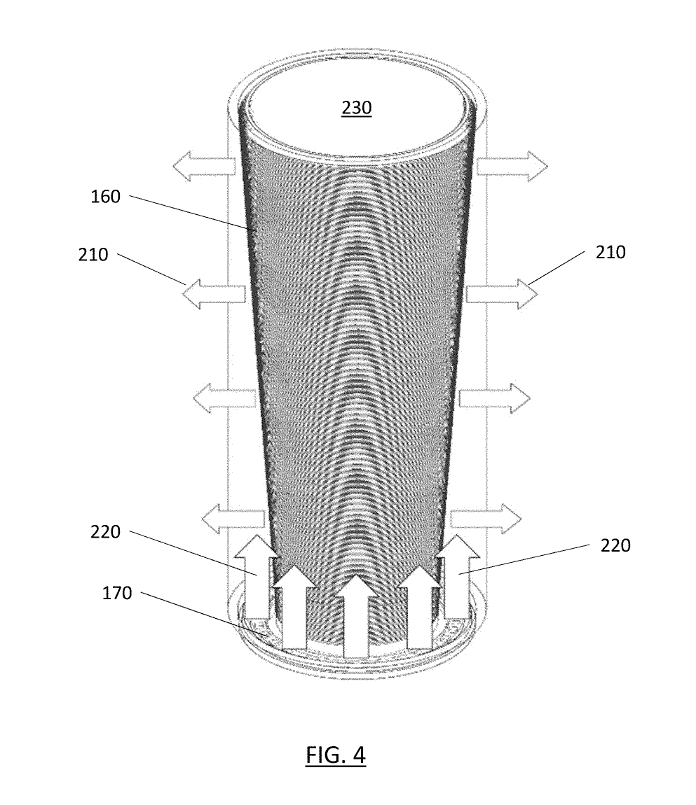

FIG. 4 illustrates the light pattern produced by the embodiment of FIG. 3, where light from the LEDs 170 is primarily emitted along the axis of emission along arrows 220 toward the redirector 160. The light encounters the steps 168 of the redirector 160 and is reflected or redirected in the direction represented by arrows 210. While the light path 210 is generally perpendicular to the light emitted by the LEDs 170 along 220, the steps 168 can be structured to reflect or redirect the light in any chosen direction compatible with the angle of approach 220.

While the above-described embodiment generally refers to a “redirector” as causing the light emitted from the LEDs to be re-directed away from the lantern, the “redirection” of light may be caused by one or both of reflection or refraction of light as it reaches the redirector 160. In this manner, a refracting lens can function as a “reflector” or a “light guide” by using facets of the lens to reflect or redirect the light along the desired path. Referring back to FIG. 3, a refracting lens or light guide may include a solid, transparent material, such as polycarbonate (PC), poly (methyl methacrylate) (PMMA), or glass, for example, and may be formed with a hollow center. The area between the outer surface 165 and the redirector 160 surface may be of this solid material, with the steps of the redirector surface formed into the material. Light emitted from the LEDs 170 may pass through the solid, transparent material and encounter the surfaces of the steps in the same manner they would with a reflector, and the surface of the step may cause the light to be reflected in the same manner as illustrated in FIG. 4. In such an embodiment where a light guide or refractor lens is used to redirect light from the LEDs, the material of the redirector 160 may be transparent (or at least translucent), such that the cavity 230 is visible through the redirector 160. While the cavity may in some embodiments be visible, in other embodiments, it may be desirable to shield the cavity from view, which may be done using an insert, such as a frustoconical insert that resembles the shape of the frustoconical redirector. Alternatively, a shield within the cavity may be a cylinder having a diameter to fit within the narrow end of the frustoconical redirector 160.

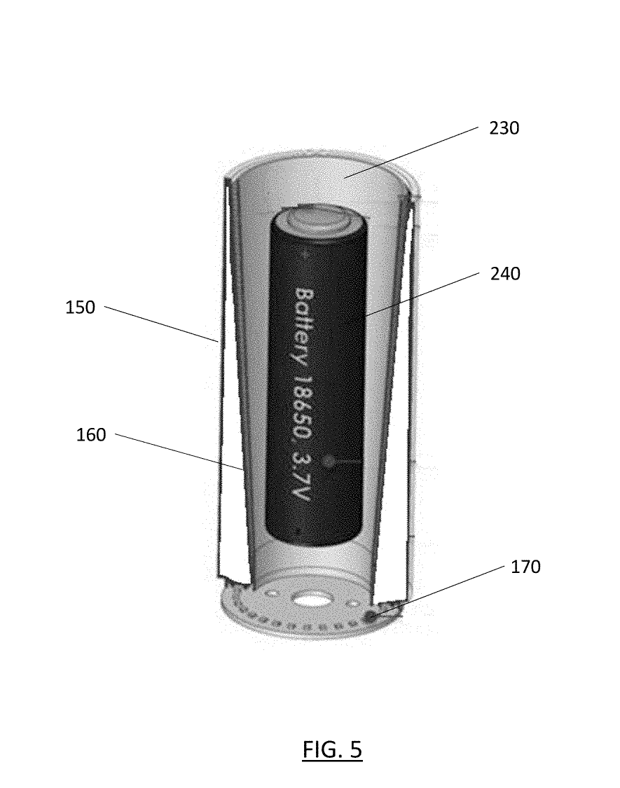

Whether the frustoconical shape of the redirector is a reflector or a refractor, the effect of redirection of the light emitted from the light source along the path shown in FIG. 4 is the same. The shape of the redirector 160 results in a cavity defined within the redirector between the wide end 162 and the narrow end 164. The cavity 230, illustrated in FIG. 4, may receive, at least partially therein, a power source for the LEDs 170. The power source may be a battery or capacitor to enable the lantern 100 to function wirelessly, without requiring an external power source. FIG. 5 illustrates a cut-away view of a portion of the lantern including the redirector 160 and the cavity 230 defined therein. FIG. 5 also illustrates a power source 240 in the form of a battery received within the cavity 230. The lantern may be configured to be powered by any type of battery, such as a nickel-cadmium (NiCad) battery, a lithium-ion battery, a nickel-metal hydride battery, a lead-acid battery, or the like. The battery may be a rechargeable battery, in which case the lantern may be configured with circuitry to enable the lantern to be plugged into an external power source in order to charge the battery 240 while received within the cavity 230. The battery 240 may optionally be removable from the cavity 230. The base of the lantern may be removable to provide access to the cavity for insertion, removal, and replacement of a power source such as a battery.

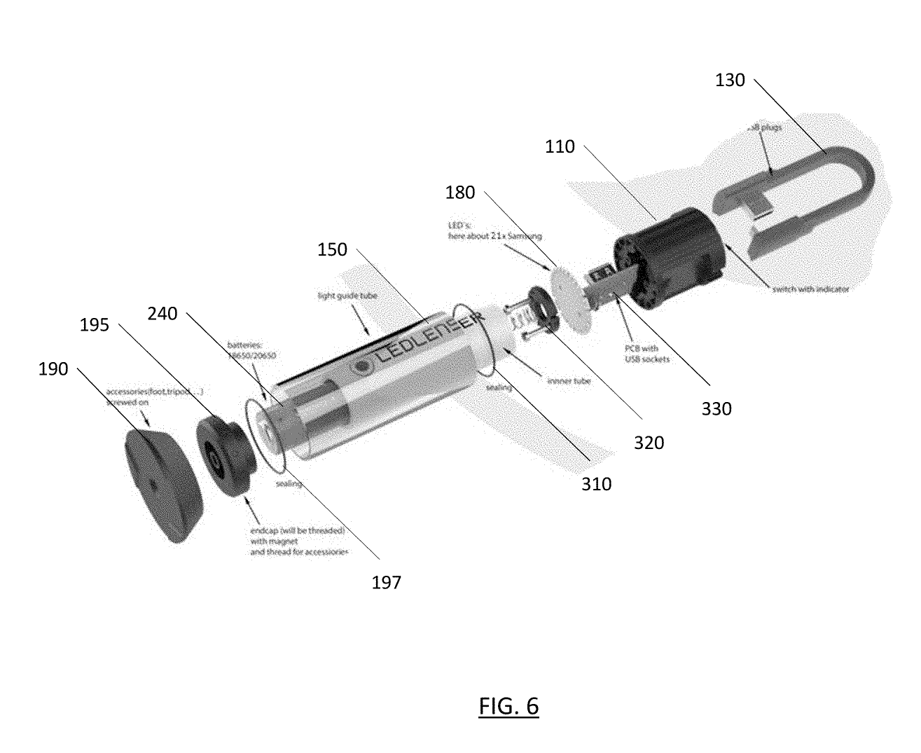

Using the cavity 230 within the redirector 160 to receive or at least partially receive the power source enables the lantern to be embodied by a more compact form factor. FIG. 6 illustrates an exploded view of an example embodiment of a lantern illustrating the advantages of a power source received within the cavity 230 of the frustoconical redirector 160. The exploded view shows the base 190, which is received about the cylindrically-shaped lantern end or cap 195 of the cylindrical housing 150. The power source 240 is received within the cavity defined by the frustoconical redirector 160 within the housing 150. According to some embodiments, a seal, such as an O-ring 197, may be disposed at the interface between the end cap 195 and the housing 150. Such a seal may serve to make the housing waterproof or water resistant, dust and dirt proof, and may seal the cavity to preclude fluids, such as leaked battery fluid, from escaping the housing 150 of the lantern.

Opposite the end cap 195 is the lantern top 110. The lantern top 110 may house a circuit board 330 which may be used for a power switch that may be disposed on the lantern top 110. The circuit board may also serve as an LED driver to electrically communicate power from the power source 240 to the LED circuit board 180, and in turn to the LEDs 170. The battery may be in electrical communication with the circuit board 330 via a power source interface 320. According to some embodiments, the power source 240 may have both the positive and ground or negative terminals at an end of the power source proximate the power source interface 320. Optionally, in an instance in which the power source 240 has positive and negative terminals at opposite ends (e.g., one terminal near end cap 195 and the other proximate power source interface 320), the end cap 195 may be configured to electrically communicate with the circuit board 330 via an electrical conduit (e.g., wire or trace) through the cavity of the housing 150.

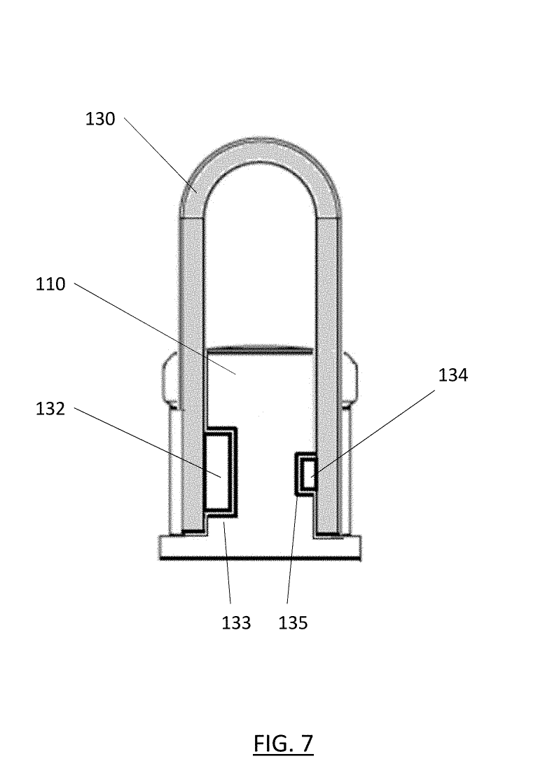

The lantern may be provided with external power in certain circumstances to power the LEDs 170 and/or to charge the power source 240. According to the illustrated embodiment, the handle 130 functions as both a handle and a charging cord. FIG. 7 illustrates a section view of the top of the lantern 110. As shown, the handle 130 is arranged in a carry or hanging position, with both ends of the handle 130 attached to the top of the lantern 110. The handle 130 includes proximate a first end a first connector 132, such as a Universal Serial Bus (USB) connector. The first connector 132 is received within a first port 133 of the top of the lantern 110. The handle 130 includes a second connector 134 proximate a second end of the handle. The second connector, which may be, for example, a micro-USB connector, is received within a second port 135 of the top of the lantern. The first connector 132 and second connector 134 are in electrical communication with one another through the handle 130. The first port 133 and the second port 135 each serve as power receiving ports for the lantern. Further, the first port 133 and second port 135 may serve as charging ports to charge peripheral devices, such as a mobile device or phone, using the power supply of the lantern.

The first connector 132 of the handle 130 can be disconnected from the first port 133 of the top of the lantern 110, while the second connector 134 remains connected to the second port 135. In this position, plugging the first connector into a power source serves to provide power through the handle, into the second port 135 of the top of the lantern 110 to charge the power source or to power the LEDs. Conversely, with the first connector 132 plugged into the first port 133, and the second connector 134 removed from the second port 135 and plugged into a power source, power would be provided to the lantern to charge the power source or power the LEDs. This way, the lantern is configured to be powered from two different sizes and types of power supply connection ports (e.g., USB and micro-USB, although the lantern may be configured to be powered from other sizes and types of power supply connection ports). Types of power supply connection ports may include USB, coaxial power cable connectors (e.g., M1-M9 sizes), RCA connectors, 3.5 millimeter jack, 2.5 millimeter jack, etc. The first port 133 or the second port 135 may also facilitate pass-through charging, such as when a connector providing power is plugged into the first port 133 or the second port 135, a peripheral device may be plugged in to the other of the first port 133 or the second port 135 and receive power through the connectors of the lantern from the connector providing power. The pass through power to a peripheral device may be provided while the power source of the lantern is also being charged.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A light emitting apparatus comprising:
a redirector disposed about an axis, the redirector having a first end and a second end, wherein the first end is narrower than the second end, the redirector defining a cavity between the first end and second end;
a power source receiving area at least partially disposed within the cavity defined by the redirector; and
a light source disposed around the redirector proximate the first end of the redirector about the axis, wherein the light source is powered by a power source received within the power source receiving area and is configured to project light substantially parallel to the axis, toward the second end of the redirector.

2. The light emitting apparatus of claim 1, wherein the redirector comprises a frustoconical shape.

3. The light emitting apparatus of claim 2, wherein an outer surface of the frustoconical shape comprises a microstructure of a plurality of angled steps.

4. The light emitting apparatus of claim 3, wherein the plurality of angled steps are arranged concentrically about the axis and offset along a length of the axis to form the frustoconical shape.

5. The light emitting apparatus of claim 1, wherein the power source is received entirely within the cavity defined between the first end and the second end of the redirector.

6. The light emitting apparatus of claim 1, wherein the light source comprises a plurality of light emitting diodes arranged on a circuit board, wherein the circuit board is positioned at the first end of the redirector in a plane orthogonal to the axis of the redirector.

7. The light emitting apparatus of claim 6, wherein the plurality of light emitting diodes are configured with a primary axis of emission along which a relatively higher proportion of light emitted from the diode is directed, wherein the primary axis of emission is parallel to the axis of the redirector.

8. The light emitting apparatus of claim 1, further comprising a base positioned at the second end of the redirector and a top positioned at the first end of the redirector, wherein the top comprises a cavity defined therein housing a light emitting diode drive circuit board and a power switch configured to turn the light source on and off.

9. The light emitting apparatus of claim 8, wherein the top further comprises a first connection port and a second connection port, wherein one of the first connection port and the second connection port are charge ports used to charge the power source of the apparatus, and wherein the other of the first connection port and the second connection port is configured to provide power to a device connected to said other connection port.

10. The light emitting apparatus of claim 9, wherein the first connection port is a micro universal serial bus (micro-USB) port and the second connection port is a standard universal serial bus (standard USB) port.

11. The light emitting apparatus of claim 10, further comprising a cable configured to connect to both the first connection port and the second connection port, wherein:
the cable functions as a handle in response to being connected to both the first connection port and the second connection port at the same time;
the cable functions as a power input charging cable in response to being plugged into the first connection port and a powered standard USB port; and
the cable functions as a power output charging cable in response to being plugged into the second connection port and a micro USB port.

12. The light emitting apparatus of claim 8, further comprising a lens disposed between the base and the top and surrounding the redirector about the axis.

13. A redirector for a light emitting apparatus comprising:
a generally frustoconical body extending along an axis between a first end and a second end, wherein the first end has a first diameter and the second end has a second diameter, larger than the first diameter;
a cavity defined within the body between the first end and the second end; and
a plurality of concentric steps arranged along the frustoconical body, wherein the concentric steps each comprise a first portion and a second portion, wherein the first portion comprises a substantially cylindrical surface extending about and parallel to the axis, and wherein the second portion comprises an interface between the first portions of adjacent steps.

14. The redirector of claim 13, wherein the second portion comprises a radiused surface between the first portions of adjacent steps.

15. The redirector of claim 13, wherein the second portion of each step is configured to reflect light received along an illumination axis parallel to the axis of the body.

16. The redirector of claim 13, wherein at least the second portion of each step comprises a light guiding material or a reflective material.

17. The redirector of claim 13, wherein the cavity is configured to receive therein a power source for providing power to a light source disposed about the first end of the redirector body.

18. A light emitting apparatus comprising:
a generally frustoconical redirector extending along an axis between a first end and a second end, wherein the first end has a first diameter and the second end has a second diameter, larger than the first diameter;
a plurality of concentric steps arranged along the frustoconical body, wherein the concentric steps each comprise a first portion and a second portion, wherein the first portion comprises a substantially cylindrical surface extending about and parallel to the axis, and wherein the second portion comprises an interface between the first portions of adjacent steps; and
a light source disposed about the redirector proximate the first end of the redirector and configured to emit light along an axis of major emission toward the second end of the redirector.

19. The light emitting apparatus of claim 18, wherein the axis of major emission is substantially parallel to the axis of the redirector, and wherein the second portion of each of the steps of the redirector is configured to reflect the light emitted by the light source.

20. The light emitting apparatus of claim 19, wherein the generally frustoconical redirector defines a cavity therein, wherein the cavity is configured to at least partially receive therein a power supply for providing power to the light source.
